(19) United States
(12) Patent Application Publication
(10) Pub. No.: US 2018/0179402 A1
(43) Pub. Date: Jun. 28, 2018

(54) Method for Producing Peelable Coatings on Metal Substrates

(71) Applicant: Akzo Nobel Coatings International B.V., Arnhem (NL)

(72) Inventors: Christoph Piecha, Stadland (DE); Dirk Seeger, Oldenburg (DE)

(21) Appl. No.: 15/738,676

(22) PCT Filed: Jun. 8, 2016
(86) PCT No.: PCT/EP2016/062986

§ 371 Date: Dec. 21, 2017

(30) Foreign Application Priority Data
Jul. 7, 2015 (EP) 15175615.2

(51) Int. Cl. C09D 7/40; C09D 5/20; C09D 7/61; C09D 7/63; C09D 171/02; C23F 1/04

(52) U.S. Cl. CPC C09D 7/70; C09D 5/20; C09D 7/69; C23F 1/04; C09D 7/63; C09D 171/02; C09D 7/61

(57) ABSTRACT

The present invention relates to a process for producing a peelable coating on metallic substrates, which comprises (1) providing a metallic substrate, (2) applying a peelable lacquer to the metallic substrate, and (3) curing the peelable lacquer applied, in which, the peelable lacquer comprises microhollow spheres. The present invention also relates to a process for the chemical milling of metallic substrates.

The present invention relates to a process for producing peelable coatings (that is to say peelable lacquer layers, on metallic substrates. The present invention likewise relates to the peelable coatings produced by the process and arranged on metallic substrates. The coatings can, for example, be taken off selectively from the substrate surface. In the case of selective peeling, this can take place very exactly and variably in such a manner that, after the peeling, a surface optimally adapted to the individual circumstances results. This means that, after the peeling, an exactly adapted fraction of the substrate surface is exposed (namely the part from which the coating was taken off) and an equally adapted part of the surface is still covered by the coating. For this reason, the coating composition and the coating are outstandingly suitable for selective chemical milling of metal substrates such as, for example, as used in aircraft construction. The present invention accordingly also relates to a process for the chemical milling of metallic substrates.

### PRIOR ART

In the sector of aircraft construction, various metals and metallic alloys are used as basic construction materials for the construction of outer skins of aircraft. The individual components produced from these basic construction materials must be adjustable to differing thicknesses, depending on their load-bearing capacity and the total statics of the aircraft. In addition, the final weight of an aircraft plays a critical role for the subsequent economic efficiency of the aircraft. For this reason, as early as in the construction phase of an aircraft, there are already great efforts to permit weight reduction in an individual component while retaining quality and stability. Calculations have demonstrated that in many components there is a potential in certain segments to decrease the thickness of the component without adversely affecting the load-bearing capacity or the statics. For this reason, by selectively thinning out defined segments of a component, there is a very great potential for reducing the overall weight of an aircraft.

On account of the outstanding properties such as, for example, high strength and high corrosion resistance with flexibility at the same time, and the relatively low weight, aluminum components or components made of aluminum alloys are preferably used in aircraft construction.

Owing to technical limitations, mechanical milling is not used for adjusting the thickness of various segments of the components. Instead, chemical milling baths are used. These chemical milling baths can be alkaline or acidic. Alkaline milling baths are predominantly used. These contain 5 to 35% strength NaOH solutions, for example, and have temperatures in the range from 60 to 100° C. Milling processes in alkaline milling baths generally last for between 4 and 6 hours. Milling baths that have an acidic pH contain, for example, 32% strength nitric acid and the usual milling times are about 30 minutes.

Milling proceeds via complete immersion of the components that are to be processed in the respective milling baths. Since the entire component is immersed in the milling baths and thereby covered completely with chemicals, regions that are not to be milled must be protected. This is performed predominantly by coatings which are produced before the milling process by application and curing of corresponding coating compositions on the component. In this case the components are first completely coated and subsequently, the component segments that are to be milled are demasked by selective peeling of the coating. The selective peeling is generally achieved by incision of the coating, or cutting out the corresponding regions of the surface that are to be demasked using appropriate blade devices.

Coating compositions (also termed lacquers), termed peelable lacquers (also termed masking lacquers) that are usable in this context are adequately known and are described, for example, in U.S. Pat. No. 3,661,840, U.S. Pat. No. 3,544,400 or else WO97/35932. As specified in EN ISO 4618:2006 (April 2007 version), a peelable lacquer is defined as a coating material which can be removed again from a substrate, to which it has been applied as a temporary protection, by peeling. Accordingly, a peelable lacquer layer is a coating which can be removed again from a substrate by peeling. The expression “peeling” in this context describes the residue-free removal of a coating from a substrate by the action of a mechanical tensile force.

Corresponding requirements of such a masking lacquer therefore comprise a suitable chemical resistance to acids and bases from the chemical milling baths and also a controlled adhesion of the coating produced using the masking lacquer (that is to say peelable lacquer layer) which permits a residue-free peeling of the coating. A peelable lacquer is therefore a lacquer or a coating composition which has the abovementioned properties, that is to say is suitable in this sense. The individual adjustment of corresponding lacquers and adaptation to the circumstances of the individual case, for example to the type of substrate or the type of chemical milling bath to be used are possible without problems to a person skilled in the art and can be achieved by only a few targeted experiments. Further information may additionally be found in the description hereinafter.

However, a still-existing problem of peelable lacquers or coatings produced therefrom and corresponding milling processes lies in the accuracy and selectivity of the milling. The main problem is that the cuts present after the incision have very poor visibility. As a result, maintaining the predetermined cutout shapes and in particular the successive feeding of cut edges is made much more difficult. Some attempts have been made to counteract the problem by a defined coloring of the peelable lacquer and thereby the coating. However, this has proved to be inadequate.

### Problem

The problem underlying the present invention was therefore to eliminate the above described disadvantages of the prior art. It should provide the possibility, in the context of chemical milling of metallic substrates, of increasing the accuracy and selectivity of this process owing to the better visibility of cut edges in the peelable lacquer layers used here.

### Solution

Accordingly, a novel process for producing a peelable coating on metallic substrates has been found, which comprises
(1) providing a metallic substrate,
(2) applying a peelable lacquer to the metallic substrate, and
(3) curing the peelable lacquer applied under (2),
   wherein
   the peelable lacquer comprises microhollow spheres.

The novel process is subject matter of the present invention. Preferred embodiments proceed from the following description and the subclaims. Subject matter of the present invention is also a peelable coating arranged on a metallic substrate, which peelable coating was produced by the process.

Equally subject matter of the present invention is a process for the chemical milling of metallic substrates, in which
(A) a peelable coating as described above is produced on a metallic substrate,
(B) the metallic substrate is partially demasked by partial peeling of the peelable coating produced under (A), and
(C) the structure obtained under (B) is immersed in a chemical milling bath and chemically milled.

Subject matter of the present invention is likewise therefore also a structure that is chemically milled by the process and also the use of a peelable lacquer containing microhollow spheres in the context of the chemical milling of metallic substrates.

The peelable coating may be peeled from the metallic substrate in a very accurate and selective manner. This is because correspondingly introduced cut edges in the peelable coating are extremely highly visible and accordingly permit the correspondingly exact and selective introduction of cuts and cut shapes.

### DESCRIPTION OF THE INVENTION

In step (1) of the process for producing a peelable coating on metallic substrates, a metallic substrate is provided.

Metallic substrates that come into consideration are in principle substrates containing or consisting of, for example, iron, aluminum, copper, zinc, magnesium, and alloys thereof, and also steel in the most varied forms and compositions. Preference is given to substrates made of aluminum and/or aluminum alloys, in particular the known alloy aluminum 2024. The substrates can in principle be of any desired shape, that is to say they can be, for example, simple sheets, or else complex components such as, in particular, aluminum components, or components made of aluminum alloys from aircraft construction.

In step (2), a peelable lacquer is applied to the metallic substrate. The peelable lacquer is also applied directly to the substrate. That is to say between the peelable lacquer layer finally resulting, and the substrate, no further layers are arranged, but the peelable lacquer layer and the substrate are in direct contact with one another.

It is of importance, in addition to the fact that microhollow spheres are present, only that the coating composition designated as peelable lacquer is suitable as precisely such a peelable lacquer, accordingly, therefore, has the properties already described at the outset. The lacquer must therefore be configured in such a manner that the peelable lacquer layers produced using the peelable lacquer have a certain chemical resistance to acids and bases from the milling baths and also a controlled adhesion to metallic substrates which permit a residue-free peel of the lacquer layer. Such lacquers and the components present therein are well known to those skilled in the art.

The peelable lacquer can be applied by the methods known to those skilled in the art for application of coating compositions, for example by immersion, knife application, spraying or rolling. From the methods mentioned, it follows that the peelable lacquer is preferably a coating composition that is free-flowing at processing temperature. This is because the methods cited are provided for a corresponding composition. It is therefore preferred, in particular, that the peelable lacquer is free-flowing under standard conditions (25° C., 1.013 bar). Preferably, spray application methods are employed, such as, for example, compressed-air spraying (pneumatic application), airless spraying, high-speed rotation, electrostatic spray application (ESTA), optionally together with hot-spray application such as, for example, hot-air (hot spraying).

In step (3) of the process, the peelable lacquer applied in step (2) is cured. Curing an applied lacquer, or a lacquer layer, is, as is known, conversion of such a layer into the ready-to-use state, that is to say into a state in which the substrate furnished with the respective coating layer can be transported, stored and properly used. A cured coating layer is, therefore, in particular no longer soft or sticky, but conditioned as a solid coating film which no longer significantly changes its properties such as hardness or adhesion to the substrate even with further exposure to curing conditions.

The curing proceeds in each case in a manner adapted to the peelable lacquer selected in the individual case. Such an adaptation can be carried out without problem by those skilled in the art. In the case of physically and/or thermally and chemically curable peelable lacquers that are fundamentally preferred in the context of the present invention, particularly preferably thermally and chemically curable peelable lacquers, curing thereby can proceed as is known, for example, at temperatures from 15 to 250° C. for a time of, for example, 5 minutes up to several days, for example 7 days. Temperature and time of curing are as is known dependent on many factors to be adapted to in the individual case, for example on whether these are thermally and chemically curable single-component systems, or two-component systems. Before curing, the applied peelable lacquer can of course also be ventilated or intermediately dried in a known manner.

The peelable lacquer can be applied in such a manner that the peelable lacquer layer, after curing, has a dry layer thickness of, for example, 50 to 800 micrometers, preferably 100 to 600 micrometers. A layer thickness determination can be carried out by means of a modular layer thickness measurement system from Qnix®8500.

It is obviously preferable that, in addition to the peelable lacquer layer, no further coating medium composition is applied. In the context of the process, therefore, preferably one-layer coated metal substrates are produced.

The peelable lacquer to be used in the context of the process contains microhollow spheres, but otherwise can be freely selected and adapted to the circumstances of the individual case.

It is of importance, in addition to the fact that microhollow spheres are present, only that the coating composition designated as peelable lacquer is suitable as precisely such a peelable lacquer, accordingly, therefore, has the properties already described at the outset. The lacquer must therefore be configured in such a manner that the peelable lacquer layers produced using the peelable lacquer have a certain chemical resistance to acids and bases from the milling baths and also a controlled adhesion to metallic substrates which permit a residue-free peel of the lacquer layer. Such lacquers and the components present therein are well known to those skilled in the art.

Generally, a peelable lacquer in any case has at least one organic polymer as a binder. These organic polymers are, for example, but not exclusively, the polyurethane, polyester, polyether, alkyd, polystyrene, epoxy resins known to those skilled in the art, and also copolymers of said resins. The use of polyacrylic and polymethacrylic resins that are known per se (hereinafter termed poly(meth)acrylic resins) is likewise possible. The same applies to polymers of the group of the polystyrene-alkylene copolymers and also the polyethylene and/or polypropylene homopolymers and copolymers.

As is known, coating media can in principle be cured physically and/or chemically, depending on the components present such as binders and crosslinking agents. In chemical curing, in particular, thermal and chemical curing comes into consideration. A coating medium can, for example, if it is thermally and chemically curable, be self-crosslinking and/or externally crosslinking. The statement that a coating medium is self-crosslinking and/or externally crosslinking, in the context of the present invention, is taken to mean that this coating medium contains polymers as binders and optionally crosslinking agents which can accordingly crosslink with one another. The underlying mechanisms and usable binders and crosslinking agents are known.

In the context of the present invention, “physically curable” or the expression “physical curing” means the formation of a cured coating layer by release of solvent from polymer solutions or polymer dispersions, wherein the curing is achieved by an entanglement of polymer chains. Such coating media are generally formulated as single-component coating media.

In the context of the present invention, “thermally and chemically curable”, or the expression “thermal and chemical curing”, means that the composition can crosslink or cure, initiated by chemical reaction of reactive functional groups, wherein the energetic activation of this chemical reaction is possible by thermal energy. In this case, different functional groups which are complementary to one another can react with one another (complementary functional groups) and/or the formation of the cured layer is based on the reaction of autoreactive groups, that is to say, therefore, functional groups which react among one another with groups of their type. Examples of suitable complementary reactive functional groups and autoreactive functional groups are, for example, known from the German patent application DE 199 30 665 A1, page 7, line 28, to page 9, line 24. Likewise, the oxidative curing of alkyd resins that are known per se is to be assigned to thermal and chemical curing.

Preferably, the peelable lacquer is a thermally and chemically curable coating composition. The coating medium compositions that are known in principle which are self-crosslinking and/or externally crosslinking are possible. Self-crosslinking systems are generally formulated as single-component systems. Particular preference is given to thermally and chemically curable coating medium compositions which are externally crosslinking. Among the latter, for example, the single-component and two-component systems that are known per se are possible.

Accordingly, the peelable lacquers preferably contain a (first) polymer as binder which contains certain functional groups, for example hydroxyl groups, and also a crosslinking agent that is known per se, for example a polyisocyanate and/or melamine resin, wherein, then, binder and crosslinking agent can thermally and chemically cure with one another. Obviously, the crosslinking agents likewise belong to the nonvolatile fraction of the lacquer without pigments and fillers and therefore, in the meaning of the relevant standards, likewise belong to the binder fraction. The same applies to additives such as, for example, wetting agents and/or dispersants, antifoams, flow control additives, rheology additives, or catalysts, where these are nonvolatile under the conditions for determining the binder content. The terminology “polymer as binder” and “crosslinking agent” used in the context of the present invention is merely chosen for the sake of better clarity.

In corresponding single-component systems, the components that are to be crosslinked, for example organic polymers, as binders, and crosslinking agents, are present simultaneously, that is to say in one component. A precondition thereof is that the components that are to be crosslinked first react with one another, that is to say participate in cure reactions, at relatively high temperatures of, for example, above 100° C. As an exemplary combination, hydroxy functional polyesters and/or polyurethanes with melamine resins and/or blocked polyisocyanates may be mentioned as crosslinking agents.

In corresponding two-component systems, the components that are to be crosslinked, for example the organic polymers, as binders, and the crosslinking agents, are present separately from one another in at least two components which are first added shortly before the application. This form is selected when the components that are to be crosslinked already react with one another at ambient temperatures or slightly elevated temperatures of, for example, 40 to 90° C. As an exemplary combination, mention may be made of hydroxy functional polyesters and/or polyurethanes and/or poly(meth)acrylates (in the parent lacquer component) with free polyisocyanates as crosslinking agents (in the curing agent component).

Of course, in the curing of a coating medium characterized as thermally and chemically curable, a physical curing, that is to say an entanglement of polymer chains, always occurs also. Nevertheless, such a coating medium is then termed as thermal and chemical.

It follows from the above that the peelable lacquers used preferably contain as binders those of the abovementioned organic polymers which contain functional groups for chemical crosslinking. Preference in this case is given to hydroxyl groups. It likewise follows from the above that preferably at least one crosslinking agent is present, wherein polyisocyanates containing free or blocked isocyanate groups are preferred.

Again, more preference is given to thermally and chemically curable two-component peelable lacquers which contain at least one hydroxy functional polymer as binder, in particular at least one hydroxy functional polyurethane, polyester, polyether, polystyrene, poly(meth)acrylic, epoxy resin and/or copolymer of said resins, in the parent lacquer component and at least one polyisocyanate containing free isocyanate groups in the curing agent component. Such peelable lacquers have proved themselves in the past with respect to chemical resistance and controlled peelability.

Reference has already been made above to the properties of a peelable lacquer and the coatings produced therefrom, in particular to the residue-free possible peeling of such coatings from metal substrates. Achieving this peelability or a correspondingly controlled adhesion may be achieved by various ways which are known per se.

In the context of the present invention, preferred possibilities which lead to a good suitability as peelable lacquer are detailed hereinafter.

Firstly, it is possible to use as binders organic polymers which, owing to the physicochemical properties thereof lead to coatings having appropriately low adhesion, in such a manner that they are peelable. Reference may be made by way of example to polystyrene-alkylene copolymers, polyethylene and/or polypropylene homopolymers and copolymers as binders, which in this sense are also preferred.

It is also possible to use thermally and chemically curable two-component lacquers which have a very short pot time owing to the polymers present as binders and also likewise crosslinking agents that are to be used. Such systems then cure very rapidly after application to a substrate, without needing to develop a particularly strong adhesion to the substrate. Particular preference is given in this context to thermally and chemically curable two-component peelable lacquers which contain at least one hydroxy functional polymer as binder and also an organic diamine, preferably an aromatic diamine, in the parent lacquer component and contain at least one polyisocyanate containing free isocyanate groups in the curing agent component.

A further alternative or additional possibility to the two abovementioned possibilities is the use of anti-adhesion agents that are known per se. These are in principle commercially available additives which can reduce the strong adhesion to various substrates. They are, for example, esters of fatty acids or silicone oils. Mixed salts of aminocarboxylic acids, for example a sodium/triethylammonium salt of an aminocarboxylic acid, that are known per se are also possible. Reference may be made by way of example to the commercially available products Additol VXL 1105, Additol XW 6568 or Additol VXL 6383. Preference is given in this context when the peelable lacquer contains an amount of 1 to 5% by weight, based on the total amount of the peelable lacquer, of at least one anti-adhesion agent.

It is therefore preferred that the peelable lacquer (i) contains at least one polymer as binder selected from the group of the polystyrene-alkylene copolymers, polyethylene- and/or polypropylene-homopolymers and copolymers, or (ii) is a thermally and chemically curable two-component peelable lacquer which contains at least one hydroxy functional polymer as binder and also an organic diamine, preferably an aromatic diamine, in the parent lacquer component and contains at least one polyisocyanate containing free isocyanate groups in the curing agent component. Since, in the context of the present invention, in principle thermally and chemically curable two-component peelable lacquers are preferred, alternative (ii) is again preferred.

In a further preferred embodiment which optionally can also be combined with the abovementioned embodiments (i) and (ii), the peelable lacquer contains an amount from 1 to 5% by weight, based on the total amount of the peelable lacquer, of at least one anti-adhesion agent.

As further components, the peelable lacquer can contain, for example, pigments, fillers and solvents such as organic solvents and/or water, and also other typical lacquer additives such as deaerating agents, rheological additives such as thixotropic agents, catalysts and molecular sieves.

It is essential to the invention that the peelable lacquer contains microhollow spheres.

Such microhollow spheres are known per se. These are what are termed light fillers, wherein the spheres are filled with, for example, air, nitrogen or carbon dioxide. The sphere shells comprise, for example, glasses such as borosilicate glasses, silicates such as aluminosilicate, silicon dioxide, ceramics and/or plastics, also, such as plastomers, for example plastomers based on styrene and/or poly(meth)acrylate or else acrylonitrile-based polymers such as polyacrylonitrile-methyl methacrylate copolymers or polyacrylonitrile polymers. Of course, mixtures of different shell materials are also possible.

The particle diameter (D50 value, volume-related) of the microhollow spheres is, for example, from 5 to 200 micrometers, preferably from 20 to 120 micrometers (determined via laser diffraction as specified in ISO 13320:2009-10).

Corresponding microhollow spheres can be obtained commercially from a variety of suppliers, for example under the trademarks Expancel DE (from AkzoNobel), 3M Glass Bubbles (from 3M) or Dualite E (from Henkel) and can readily be used in the peelable lacquer.

The fraction of the microhollow spheres is, for example, from 0.05 to 30% by weight, preferably 1 to 20% by weight, in each case based on the total amount of the peelable lacquer. The amount is dependent, for example, on various properties of the peelable lacquer used in each case, for example on the color of the peelable lacquer and can be varied according to individual cases.

The microhollow spheres can be added without problem in the desired amount to the otherwise completely formulated peelable lacquer and then mixed in. It is equally possible, of course, to add the microhollow spheres even in advance, that is to say before finishing the otherwise complete formulation. In two-component systems, the microhollow spheres can also, for example, be added to the parent lacquer component and then mixed with the curing agent component.

The solids content (also termed solids or nonvolatile fraction) of the peelable lacquer without microhollow spheres (wM) can vary within broad limits depending on the individual case. It is, for example, from 10 to 100%, preferably 20 up to 100%, further preferably from to 100%. Therefore, it can be a solvent-free or virtually solvent-free system, or the lacquer can contain significant amounts of water or organic solvents (that is to say the lacquer can be aqueous or solvent-based).

The solids are determined as specified in ISO 3251:2008 by drying 1 g of the peelable lacquer for 60 min at 105° C. The nonvolatile fraction remaining after drying is related to the initial weight and indicates the percentage of solids of the peelable lacquer.

The binder fraction of the solids of the peelable lacquer is, for example, from 45 to 95%, preferably 50 to 95%, further preferably 70 to 95% (determined by the extraction method according to Soxhlet (ISO 13944:2012; November 2012)). Accordingly, the fraction of pigments and fillers in the solids of the peelable lacquer is, for example, from 5 to 55%, preferably 5 to 50%, further preferably 5 to 30%.

The organic solvent content of the peelable lacquer is, preferably, less than 500 g/l, further preferably less than 300 g/l, very particularly preferably less than 200 g/l (grams of solvent per liter of lacquer).

The organic solvent fraction can be set or determined by taking into account the mass of organic solvent and the volume of the coating composition.

The density of the peelable lacquer is, for example, in the range from 1.05 to 1.7 g/l.

Further subject matter of the present invention is a process for the chemical milling of metallic substrates, in which
(A) a peelable coating as described above is produced on a metallic substrate,
(B) the metallic substrate is partially demasked by partial peeling of the peelable coating produced under (A), and
(C) the structure obtained under (B) is immersed in a chemical milling bath and chemically milled.

The abovementioned step (A) of the process for chemical milling therefore comprises the steps (1) to (3) that are essential to the invention of the process described further above for producing a peelable coating on metallic substrates. For the process for chemical milling, in addition, all of the abovementioned preferred embodiments apply with respect to the process for producing a peelable coating and also with respect to the peelable lacquer.

In step (A) of the process for chemical milling, therefore, a peelable coating is produced on a metallic substrate.

In step (B) of the process, the metallic substrate is partially demasked by partial peeling of the peelable coating.

After ending step (B), therefore, a defined fraction of the substrate surface is open, that is to say it is no longer covered by a coating. The residual fraction of the surface, however, is of course still covered by the peelable (but not yet peeled) coating.

The demasking step (B) in this case preferably comprises incising the peelable coating. The coating is therefore prepared by mounting a cutting instrument, for example a cutter blade or a scalpel, and subsequent incision and optionally cutting out of defined shapes, optionally using auxiliaries such as cutting templates, or a straight edge, in such a manner that a part of the coating can be taken off. The incision, or the cutting out, can of course be also carried out by automated cutting systems. Subsequently, the part of the coating that is to be taken off is taken off from the substrate surface using suitable equipment or by hand.

In step (C) of the process, there then follows the immersion into a chemical milling bath and the chemical milling of the structure obtained by step (B), that is to say the partially coated metallic substrate.

Corresponding chemical milling baths can be, for example, acidic or alkaline. In the context of the present invention, it is possible to use acidic chemical milling baths having a pH of less than 7, preferably less than 6, very particularly preferably −1 to 5, or alkaline chemical milling baths having a pH of greater than 7, preferably greater than 8, very particularly preferably 9 to 15.

Acids or bases that can be used are the components that are known per se, in particular inorganic components such as hydrochloric acid, nitric acid, sulfuric acid and/or hydrofluoric acid, or sodium hydroxide and/or alkali metal aluminate-containing alkali metal hydroxide solutions.

After the immersion, the structure is chemically milled. In this case, finally, the structure is simply held immersed for a certain time in the chemical milling bath, for example for a time from 1 minute to several hours such as 10 hours, depending on the chemical milling bath selected and the desired amount of metal to be milled off. The milling can be carried out at temperatures in the range between 10 and 30° C., or also at higher temperatures from 30 to 100° C.

Preferred acidic chemical milling baths contain 20 to 40% strength nitric acid (% by weight), wherein usual milling times are in the range from 5 to 30 minutes. Preferred alkaline chemical milling baths contain 10 to 40% strength sodium hydroxide solution (% by weight), wherein usually milling times are in the range from 5 to 240 minutes.

After completion of the chemical milling, the structure is removed from the chemical milling bath and then generally cleaned, wherein residues of the milling solution are removed from the component (step (D)). This generally is performed using a rinsing solution, for example water. The cleaning can be performed by active rinsing or spray washing, but also by immersion into a corresponding cleaning bath.

Of course, the fundamental steps (B) and (C) (and also (D)), depending on the individual case, can be repeated several times, wherein, then, of course, in the first repetition step (B), the milled substrate obtained after the first run of the milling process according to the invention is used. In the repetition step (B), then, a further part of the substrate can be demasked. If the structure is then immersed into a chemical milling bath in repetition step (C) and chemically milled, thereafter a structure is obtained which contains two surface fractions milled to a different intensity, whereas the fraction optionally still beneath the coating is still not milled. After optionally repeated peeling and milling and finally peeling the last fraction of the coating and optionally a last milling step then following, a metallic substrate is then obtained which is milled to different intensities on different surface regions.

The metallic substrates finally resulting have very exactly milled regions since, by the use of the above described peelable lacquer and the accordingly good visibility of cut edges, it is possible to mill very accurately and selectively.

### Examples

Various peelable lacquers were produced that contain different types and amounts of commercially available microhollow spheres. The microhollow spheres used were the following products: Scotch 3 M hollow spheres (glass, microhollow spheres 1), light filler P (ceramic, microhollow spheres 2), Expancel (polyacrylonitrile-methyl methacrylate copolymer, microhollow spheres 3), Dualite E130-095 D (polyacrylonitrile, microhollow spheres 4). Using these peelable lacquers, aluminum test sheets of alloy 2024, unplated, were then coated on both sides. For this purpose, the peelable lacquers were applied via a familiar high-pressure spray system and then cured under conditions appropriate in each case. The dry layer thicknesses were in the range from 250 to 450 micrometers. Thereafter, cuts were introduced into all coatings using a cutter blade and were assessed visually with respect to their visibility.

The assessed peelable lacquers are listed hereinafter (statement of fractions of microhollow spheres and peelable lacquers wM (without microhollow spheres) in percent by weight). The peelable lacquers 2 to 8 and 10 additionally contained an amount of 3% by weight of a commercially available anti-adhesion agent. The quality of the visibility of cuts (+=good visibility, o=moderate, visibility in principle no longer sufficient, −=very poor/unsatisfactory visibility) is likewise stated.

Peelable lacquer 1 wM (without microhollow spheres): thermally and chemically curable two-component peelable lacquer based on hydroxy functional polyoxyethylene glycol as binder and aromatic polyisocyanates containing free isocyanate groups as crosslinking agent.

Peelable lacquer 1 wM has a content of organic solvent of 1 g/l, a solids content of 99.9%, a binder fraction in the solids of 92.1% and thus a fraction of pigments and fillers in the solids of 7.9%. The density is 1.1 g/l.

Peelable lacquer 1 wM was admixed with differing types and amounts of commercially available microhollow spheres (see table 1). Table 1 also shows the results of the assessment with respect to visibility of cuts.

TABLE 1

| Peelable | 100 | 99.9 | 99 | 90 | 80 | 99.9 | 99 | 90 | | 80 | |
|---|---|---|---|---|---|---|---|---|---|---|---|
| lacquer 1 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | ∘ | + | + | + | ∘ | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 1 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | ∘ | ∘ | + | + | + | + | ∘ | ∘ | + | + |
| cuts in the | | | | | | | | | | | |
| coating | | | | | | | | | | | |

Peelable lacquer 2 wM (without microhollow spheres): thermally and chemically curable, solvent-based two-component peelable lacquer based on hydroxy functional polyacrylic resin as binder and aliphatic polyisocyanates containing free isocyanate groups as crosslinking agent.

Peelable lacquer 2 wM has an organic solvent content of 250 g/l, a solids content of 65.0%, a binder fraction in the solids of 76.9% and thus a fraction of pigments and fillers in the solids of 23.1%. The density is 1.4 g/l.

Peelable lacquer 2 wM was admixed with differing types and amounts of commercially available microhollow spheres (see table 2). Table 2 also shows the results of the assessment with respect to visibility of cuts.

TABLE 2

| Peelable | 100 | 99.9 | 99 | 90 | 80 | 99.9 | 99 | 90 | | 80 | |
|---|---|---|---|---|---|---|---|---|---|---|---|
| lacquer 2 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 2 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | − | ∘ | + | + | + | + | ∘ | + | + | + |
| cuts in the | | | | | | | | | | | |
| coating | | | | | | | | | | | |

Peelable lacquer 3 wM (without microhollow spheres): thermally and chemically curable, aqueous two-component peelable lacquer based on hydroxy functional polyacrylic resin as binder and aliphatic polyisocyanates containing free isocyanate groups as crosslinking agent.

Peelable lacquer 3 wM has an organic solvent content of 120 g/l, a solids content of 84.4%, a binder fraction in the solids of 53.3% and thus a fraction of pigments and fillers in the solids of 46.7%. The density is 1.3 g/l.

Peelable lacquer 3 wM was admixed with differing types and amounts of commercially available microhollow spheres (see table 3). Table 3 also shows the results of the assessment with respect to visibility of cuts.

TABLE 3

| Peelable | 100 | 99.9 | 99 | 90 | 80 | 99.9 | 99 | 90 | | 80 | |
|---|---|---|---|---|---|---|---|---|---|---|---|
| lacquer 3 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 3 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | + | + | + | + | + | + | + | + | + | + |
| cuts in the | | | | | | | | | | | |
| coating | | | | | | | | | | | |

Peelable lacquer 4 wM (without microhollow spheres): thermally and chemically curable, solvent-based two-component peelable lacquer based on hydroxy functional polyester resin as binder and aliphatic polyisocyanates containing free isocyanate groups as crosslinking agent.

Peelable lacquer 4 wM has an organic solvent content of 250 g/l, a solids content of 65.0%, a binder fraction in the solids of 84.6% and thus a fraction of pigments and fillers in the solids of 15.4%. The density is 1.4 g/l.

Peelable lacquer 4 wM was admixed with differing types and amounts of commercially available microhollow spheres (see table 4). Table 4 also shows the results of the assessment with respect to visibility of cuts.

TABLE 4

| Peelable | 100 | 99.9 | 99 | 90 | 80 | 99.9 | 99 | 90 | | 80 | |
|---|---|---|---|---|---|---|---|---|---|---|---|
| lacquer 4 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 4 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | o | + | + | + | + | + | ∘ | + | + | + |
| cuts in the | | | | | | | | | | | |
| coating | | | | | | | | | | | |

Peelable lacquer 5 wM (without microhollow spheres): physically curable, aqueous single-component peelable lacquer based on an aqueous dispersion of a poly(meth)acrylic resin as binder.

Peelable lacquer 5 wM has an organic solvent content of 30 g/l, a solids content of 46.1%, a binder fraction in the solids of 65.1% and thus a fraction of pigments and fillers in the solids of 34.9%. The density is 1.3 g/l.

Peelable lacquer 5 wM was admixed with differing types and amounts of commercially available microhollow spheres (see table 5). Table 5 also shows the results of the assessment with respect to visibility of cuts.

TABLE 5

| Peelable | 100 | 99.9 | 99 | 90 | 80 | 99.9 | 99 | 90 | | 80 | |
|---|---|---|---|---|---|---|---|---|---|---|---|
| lacquer 5 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 5 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | − | ∘ | + | + | + | + | + | + | + | + |
| cuts in the | | | | | | | | | | | |
| coating | | | | | | | | | | | |

Peelable lacquer 6 wM (without microhollow spheres): physically curable, aqueous single-component peelable lacquer based on an aqueous dispersion of a polyurethane resin as binder.

Peelable lacquer 6 wM has an organic solvent content of 60 g/l, a solids content of 42.2%, a binder fraction in the solids of 71.1% and thus a fraction of pigments and fillers in the solids of 28.9%. The density is 1.3 g/l.

Peelable lacquer 6 wM was admixed with differing types and amounts of commercially available microhollow spheres (see table 6). Table 6 also shows the results of the assessment with respect to visibility of cuts.

TABLE 6

| Peelable | 100 | 99.9 | 99 | 90 | 80 | 99.9 | 99 | 90 | | 80 | |
|---|---|---|---|---|---|---|---|---|---|---|---|
| lacquer 6 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | o | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 6 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | ∘ | + | + | + | + | + | + | + | + | + | + |
| cuts in the | | | | | | | | | | | |
| coating | | | | | | | | | | | |

Peelable lacquer 7 wM (without microhollow spheres): thermally and chemically curable, solvent-based single-component peelable lacquer based on an alkyd resin as binder.

Peelable lacquer 7 wM has an organic solvent content of 420 g/l, a solids content of 41.2%, a binder fraction in the solids of 85.0% and thus a fraction of pigments and fillers in the solids of 15.0%. The density is 1.4 g/l.

Peelable lacquer 7 wM was admixed with differing types and amounts of commercially available microhollow spheres (see table 7). Table 7 also shows the results of the assessment with respect to visibility of cuts.

TABLE 7

| Peelable | 100 | 99.9 | 99 | 90 | 80 | 99.9 | 99 | 90 | | 80 | |
|---|---|---|---|---|---|---|---|---|---|---|---|
| lacquer 7 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | − | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 7 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | − | ∘ | + | + | + | + | + | ∘ | + | + | + |
| cuts in the | | | | | | | | | | | |
| coating | | | | | | | | | | | |

Peelable lacquer 8 wM (without microhollow spheres): thermally and chemically curable, aqueous single-component peelable lacquer based on an alkyd resin as binder.

Peelable lacquer 8 wM has an organic solvent content of 50 g/l, a solids content of 42.5%, a binder fraction in the solids of 70.6% and thus a fraction of pigments and fillers in the solids of 29.4%. The density is 1.5 g/l.

Peelable lacquer 8 wM was admixed with differing types and amounts of commercially available microhollow spheres (see table 8). Table 8 also shows the results of the assessment with respect to visibility of cuts.

TABLE 8

| Peelable | 100 | 99.9 | 99 | 90 | 80 | 99.9 | 99 | 90 | | 80 | |
|---|---|---|---|---|---|---|---|---|---|---|---|
| lacquer 8 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | ∘ | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 8 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | ∘ | + | + | + | + | + | + | ∘ | + | + | + |
| cuts in the | | | | | | | | | | | |
| coating | | | | | | | | | | | |

Peelable lacquer 9 wM (without microhollow spheres): physically curable, solvent-based single-component peelable lacquer based on a polystyrene-alkylene copolymer as binder.

Peelable lacquer 9 wM has an organic solvent content of 700 g/l, a solids content of 16.0%, a binder fraction in the solids of 50.0% and thus a fraction of pigments and fillers in the solids of 50.0%. The density is 1.2 g/l.

Peelable lacquer 9 wM was admixed with differing types and amounts of commercially available microhollow spheres (see table 9). Table 9 also shows the results of the assessment with respect to visibility of cuts.

TABLE 9

| Peelable | 100 | 99.9 | 99 | 90 | 80 | 99.9 | 99 | 90 | | 80 | |
|---|---|---|---|---|---|---|---|---|---|---|---|
| lacquer 9 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | o | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 9 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | ∘ | + | + | + | + | + | + | + | + | + | + |
| cuts in the | | | | | | | | | | | |
| coating | | | | | | | | | | | |

Peelable lacquer 10 wM (without microhollow spheres): thermally and chemically curable, solvent-based two-component peelable lacquer based on a hydroxy functional epoxy resin as binder and polyamines as crosslinking agent.

Peelable lacquer 10 wM has an organic solvent content of 250 g/l, a solids content of 67.5%, a binder fraction in the solids of 88.9% and thus a fraction of pigments and fillers in the solids of 11.1%. The density is 1.3 g/l.

Peelable lacquer 10 wM was admixed with differing types and amounts of commercially available microhollow spheres (see table 10). Table 10 also shows the results of the assessment with respect to visibility of cuts.

TABLE 10

| Peelable | 100 | 99.9 | 99 | 90 | 80 | 99.9 | 99 | 90 | | 80 | |
|---|---|---|---|---|---|---|---|---|---|---|---|
| lacquer 10 wM | | | | | | | | | | | |
| Microhollow | | 0.10 | 1.00 | 10.00 | 20.00 | | | | | | |
| spheres 1 | | | | | | | | | | | |
| Microhollow | | | | | | 0.10 | 1.00 | 10.00 | | 20.00 | |
| spheres 2 | | | | | | | | | | | |
| Visibility of | ∘ | + | + | + | + | + | + | + | | + | |
| cuts in the | | | | | | | | | | | |
| coating | | | | | | | | | | | |
| Peelable | 100 | 99.98 | 99.95 | 99.9 | 99.5 | 99 | 97.5 | 99.9 | 99.5 | 99 | 95 |
| lacquer 10 wM | | | | | | | | | | | |
| Microhollow | | 0.02 | 0.05 | 0.10 | 0.50 | 1.00 | 2.50 | | | | |
| spheres 3 | | | | | | | | | | | |
| Microhollow | | | | | | | | 0.10 | 0.50 | 1.00 | 5.00 |
| spheres 4 | | | | | | | | | | | |
| Visibility of | o | + | + | + | + | + | + | + | + | + | + |
| cuts in the | | | | | | | | | | | |
| coating | | | | | | | | | | | |

The results of tables 1 to 10 show that the use of microhollow spheres significantly improves the visibility of cuts in the peelable coatings.

Using the above described peelable lacquer layers on metallic substrates, in addition, precisely these metallic substrates were chemically milled.

For this purpose, the procedure hereinafter was followed.

The cured peelable coatings on metallic substrates were first subjected to a tensile bond test. In this test, at the same time, a subregion of the peelable coating was removed from the metallic substrate.

In the tensile bond test, what is termed a “tensile bond value” is determined. This indicates the tensile bond force in grams that is necessary to remove a 1 cm-wide lacquer strip from the substrate (average value measured per peeled region). The value gives an indication as to how much force must be exerted in order to damask a component, and is measured as follows.

A lacquer strip having the dimensions 10×1 cm was incised with a sharp blade. Around this lacquer strip, a frame was cut which completely frames the lacquer strip and the sides of which are about 1 to 2 cm apart from the sides of the lacquer strip. This frame is then removed (that is to say peeled off from the metallic substrate). This has the effect that the actual test surface (the lacquer strip) can no longer have any contact with the residual coating. This is because such a residual contact which can be due, for example, to incompletely penetrating cut lines when the lacquer strip is being cut out, would falsify the result of the measurement that then follows. After this, the first 10 mm of the remaining lacquer strip are levered up by means of the blade already used in such a manner that a fixing point results for the spring balance that is to be clamped on later. At this fixing point, then, in order to prevent the spring balance sliding off, a retaining clip is applied transversely over the width of the surface. Then, by means of a brace, a previously calibrated spring balance is clamped on this retaining clip. Subsequently, the spring balance is orientated at a 45° angle to the substrate. As soon as the spring balance has assumed the correct angle, the lacquer strip is peeled off from the substrate in the course of 3 seconds using the spring balance. In parallel thereto, the force necessary therefore is read off from the scale of the spring balance.

A structure results which comprises a metallic substrate that is partially demasked, partially coated with a peelable coating (compare step (B) of the process).

Thereafter, the respective structure was completely transferred into an alkaline chemical milling bath previously heated to 70° C. (16% by weight sodium hydroxide in 84% by weight demineralized water) and was chemically milled there for 10 minutes (compare step (C) of the process). Subsequently, the test sheets were transferred into a waterbath to wash off the remnants of alkali metal hydroxide solution. The residence time in the waterbath was 2 minutes.

Ten minutes after the first chemical milling step, a tensile bond value was determined again on each test block and in this case a further region of the metallic substrate demasked (repetition step (B)).

Then, a second chemical milling step (repetition step (C)) was performed. The structures were in this case again transferred into the alkaline chemical milling bath already described and remained in the bath for 25 to 30 minutes. After this time, there is again a two-minute soaking in the waterbath. Subsequently to this soaking, the samples were taken out of the water for 30 seconds. This simulates draining processes in the later application, and act to introduce no, or only very small amounts of, water into the subsequent nitric acid bath.

Thereafter, a third chemical milling step was performed (without previous peeling of a further region of the coating). In this case, an acidic chemical milling bath was used (32% by weight nitric acid, 68% by weight demineralized water). The structure remained for 70 seconds in the chemical milling bath (second repetition step (C)). Thereafter, again cleaning for two minutes in the waterbath was performed. Four minutes after removal from the waterbath, again a tensile bond value was determined. A last tensile bond value was determined 18 hours after determination of the third value.

In all of the coatings studied, each of the four tensile bond values determined were in the range from 100 to 700 g, and thereby in a range usual for peelable lacquers. Furthermore, for each of the demasked and then milled regions (or boundary lines thereof to the still coated regions), the migration tendency was assessed. Only minor and intermittently observable migration events of at most 5 mm resulted. The peelable lacquers used therefore have a moderate chemical resistance to acids and bases from the chemical milling baths.

1. A process for producing a peelable coating on metallic substrates, which comprises
(1) providing a metallic substrate,
(2) applying a peelable lacquer to the metallic substrate, and
(3) curing the peelable lacquer applied under (2),
wherein, the peelable lacquer comprises microhollow spheres.

2. A peelable coating which is arranged on a metallic substrate that was produced according to the process as claimed in claim 1.

3. A process for the chemical milling of metallic substrates, in which
(A) according to claim 1 a peelable coating is produced on a metallic substrate,
(B) the metallic substrate is partially demasked by partial peeling of the peelable coating produced under (A), and
(C) the structure obtained under (B) is immersed in a chemical milling bath and chemically milled.

4. The process as claimed in claim 3, wherein the metallic substrate comprises aluminum and/or at least one aluminum alloy or consists thereof.

5. The process as claimed in claim 3, wherein the dry layer thickness of the peelable lacquer layer is 50 to 800 micrometers.

6. The process as claimed in claim 3, wherein the peelable lacquer is a physically or thermally and chemically curable coating composition.

7. The process as claimed in claim 3, wherein the microhollow spheres have a particle diameter (D50 value, volume-related) from 5 to 200 micrometers.

8. The process as claimed in claim 3, wherein the peelable lacquer has a content of organic solvents of less than 500 g/l.

9. The process as claimed in claim 3, wherein the chemical milling bath is an acidic or alkaline chemical milling bath.

10. The process as claimed in claim 3, wherein the masking lacquer is a thermally and chemically curable two-component coating composition.

11. The process as claimed in claim 10, wherein the masking lacquer comprises at least one hydroxyfunctional resin as binder and also an organic diamine in the parent lacquer component and at least one polyisocyanate containing free isocyanate groups in the curing agent component.

12. The process as claimed in claim 3, wherein the sequence of steps (B) and (C) can be carried out multiply, for example 2 to 10 times, successively.

13. The process as claimed in claim 3, wherein, in a last step (B), all of the fraction of the metallic substrate that is still coated before this step is demasked, whereby a completely demasked and selectively chemically milled metallic substrate is obtained.

14. A structure which is obtained according to the process as claimed in claim 3.

15. A metallic substrate which is obtained according to the process as claimed in claim 13.
